(19) United States
(12) Patent Application Publication
(10) Pub. No.: US 2026/0065867 A1
(43) Pub. Date: Mar. 5, 2026

(54) DISPLAY DEVICE

(71) Applicant: Sharp Display Technology Corporation, Kameyama City (JP)

(72) Inventors: Masafumi UENO, Kameyama City (JP); Hisashi WATANABE, Kameyama City (JP); Naru USUKURA, Kameyama City (JP)

(21) Appl. No.: 19/309,802

(22) Filed: Aug. 26, 2025

(30) Foreign Application Priority Data
Sep. 2, 2024 (JP) 2024-150824

(51) Int. Cl. G09G 3/34; G02F 1/1335; G02F 1/13357; G09G 5/10

(52) U.S. Cl. CPC G09G 3/3406; G02F 1/133611; G02F 1/133612; G09G 5/10; G09G 2320/0276; G09G 2340/0428; G09G 2360/144; G09G 2360/145; G09G 2360/16

(57) ABSTRACT

A display device includes a display panel, a decorative layer, a measurer, and a display controller. The decorative layer is configured to allow display light from the display panel to transmit and reflect outside light to display a pattern. The measurer is configured to measure an intensity of the outside light. The display controller is configured to control the display light according to an image displayed on the display panel and the intensity of the outside light.

### BACKGROUND

### 1. Field

The present disclosure relates to a display device.

### 2. Description of the Related Art

Japanese Unexamined Patent Application Publication No. 2001-331132 discloses a display device in which display light is visually recognized by a user at the time of turn-on of the display, and in which a pattern formed on the display surface is visually recognized by a user at the time of turn-off of the display.

When intense outside light is emitted to the display device described in Japanese Unexamined Patent Application Publication No. 2001-331132, reflection light of the outside light on the display surface having a pattern becomes more intense than the display light, and it is difficult for a user to visually recognize the display light. In the above-mentioned display device, even if display light is made more intense to facilitate a user to visually recognize the display light, when the outside light becomes weak, the display quality is reduced because the display light with an excessive intensity is used for display.

### SUMMARY

According to an aspect of the disclosure, there is provided a display device including: a display panel configured to emit display light; a decorative layer located on a display surface side of the display panel and having a pattern in plan view, the decorative layer being configured to allow at least part of the display light to transmit and reflect at least part of outside light to display the pattern; a measurer configured to measure an intensity of the outside light emitted to the decorative layer; and a display controller configured to control the display light according to an image displayed on the display panel and the intensity of the outside light measured by the measurer.

### BRIEF DESCRIPTION OF THE DRAWINGS

FIG. 1A shows a block diagram of a display device according to Embodiment 1;

FIG. 1B shows a schematic side sectional view of a display unit according to Embodiment 1;

FIG. 2 is a schematic plan view of the display unit according to Embodiment 1;

FIG. 3A shows a graph illustrating a relationship between outside light illuminance and luminance at the time of display of a black screen of the display device according to Embodiment 1;

FIG. 3B shows a graph illustrating a relationship between outside light illuminance and voltage applied to a backlight unit according to Embodiment 1;

FIG. 4A shows a block diagram of a display device according to Embodiment 2;

FIG. 4B shows a schematic side sectional view of a display unit according to Embodiment 2;

FIG. 5 is a block diagram of a display device according to Embodiment 3;

FIG. 6 shows a graph illustrating a relationship between outside light illuminance and adjustment of gamma correction of the display device according to Embodiment 3;

FIG. 7 is a block diagram of a display device according to Embodiment 4;

FIG. 8 shows a graph illustrating a relationship between input gradation value and reference value of luminance and a relationship between input gradation value and luminance before correction in the display device according to Embodiment 4; and

FIG. 9 is a flowchart illustrating a method for generating correction data of the display device according to Embodiment 4.

### DESCRIPTION OF THE EMBODIMENTS

### Embodiment 1

Hereinafter, an embodiment of the present disclosure will be described with reference to the drawings. Note that similar components in the drawings are labeled with the same symbol, and a description will be omitted. In the present disclosure, for the sake of simplicity of illustration, members labeled with the same symbol may have different scales depending on the figures, thus different types of hatching may be applied. However, the members shown in each figure of the present disclosure are only for illustration, and the scale is not limited to what is shown in the figure. In the present disclosure, if members with different types of hatching are labeled with the same symbol, the members have similar components as described above.

### Overview of Display Device

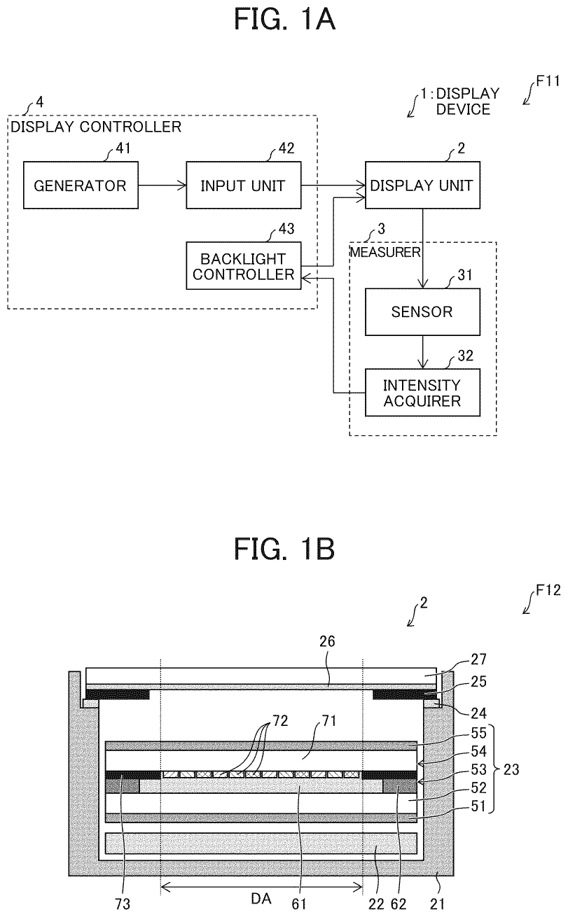

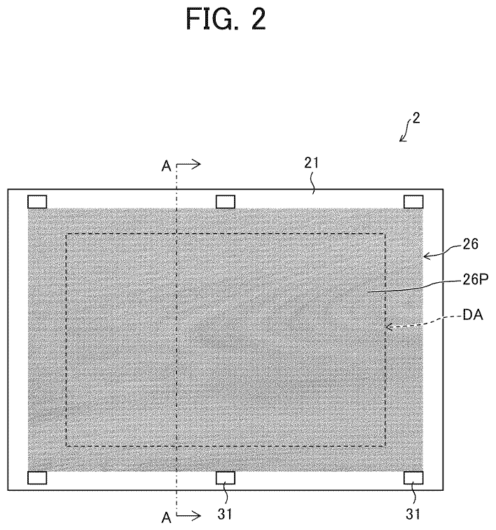

FIG. 1A shows a block diagram F11 of the display device 1 described below according to the present embodiment. FIG. 1B shows a schematic side sectional view F12 of the display unit 2 described below according to the present embodiment. FIG. 2 is a schematic plan view of the display unit 2 according to the present embodiment. In particular, the schematic side sectional view F12 is an arrow sectional view taken along line A-A indicated by a dash-dotted line in the schematic plan view of the below-described display unit 2 illustrated in FIG. 2.

The display device 1 according to the present embodiment includes a display unit 2, a measurer 3, and a display controller 4. The display device 1 displays a pattern 26P of a decorative layer 26 described below while performing display in the below-described display area DA of the display unit 2. The measurer 3 measures the intensity of outside light incident on the decorative layer 26 by the method described below. The display controller 4 uses the method described below to control the display by the display unit 2 according to the image to be displayed in the display area DA of the display unit 2, and the intensity of outside light measured by the measurer 3.

### Display Unit: Overview

The display unit 2 will be described in greater detail with reference to the schematic side sectional view F12 of FIG. 1B, and FIG. 2. The display unit 2 includes a housing 21, a backlight unit 22, a liquid crystal panel 23 as a display panel, an adhesive layer 24, a black frame layer 25, a decorative layer 26, and a transparent base material 27. As illustrated in FIG. 2, the display unit 2 has the display area DA on the central side in plan view, and performs display in the display area DA using backlight from the backlight unit 22 described below. As illustrated in FIG. 2, the display area DA may be, for example, substantially rectangular in plan view, but without being limited to this, may have various shapes such as a circle.

### Display Unit: Housing

The housing 21 has a space for storing the backlight unit 22 and the liquid crystal panel 23 described below. As long as the housing 21 can store the backlight unit 22 and the liquid crystal panel 23, the shape of the housing 21 is not limited to a specific shape, but may be, for example, a substantially rectangular parallelepiped shape having an upward opening.

### Display Unit: Backlight Unit

The backlight unit 22 is stored inside the housing 21, and emits backlight to a portion through control from the backlight controller 43 described below, the portion including an area overlapping the display area DA in plan view of the liquid crystal panel 23 described below. In the present disclosure, the “backlight” refers to the backlight emitted by the backlight unit 22 unless otherwise stated.

The backlight unit 22 may be able to change the intensity of the backlight emitted by control from the backlight controller 43 described below. In particular, the backlight unit 22 may emit backlight with intensities different from each other to portions in plan view. In this situation, for example, the backlight unit 22 may include a plurality of light emitting elements such as LEDs arranged two-dimensionally in plan view, and each of the plurality of light emitting elements may emit light with a corresponding one of the intensities. However, the backlight unit 22 may have various configurations including publicly known configurations in related art as long as the configurations do not affect the display in the display area DA described below.

### Display Unit: Liquid Crystal Panel: Overview

The liquid crystal panel 23 is located in part inside the housing 21, the part being irradiated with backlight by the backlight unit 22. For example, the liquid crystal panel 23 is located above the backlight unit 22.

The liquid crystal panel 23 changes the transmittance of backlight at each position in plan view by the method described below, thereby implementing display in the display area DA using the transmitted backlight as the display light. In particular, the liquid crystal panel 23 may have a plurality of sub-pixels arranged two-dimensionally at positions overlapping the display area DA in plan view, and may change the transmittance of emitted backlight in each of the sub-pixels.

The liquid crystal panel 23 includes, for example, a first polarizer 51, a circuit substrate 52, a liquid crystal layer 53, a color filter layer 54, and a second polarizer 55 which are layered from the backlight unit 22 in that order.

### Display Unit: Liquid Crystal Panel: Polarizer

The first polarizer 51 and the second polarizer 55 are disposed so that the polarization directions of transmitted light are different from each other. The first polarizer 51 and the second polarizer 55 may include respective linear polarizers, and may be disposed so that the polarization directions of the linear polarizers are perpendicular to each other. Alternatively, the first polarizer 51 and the second polarizer 55 may each be a circular polarizer, and in this situation, the first polarizer 51 and the second polarizer 55 may include a linear polarizer and a ¼ waveplate.

Display Unit: Liquid Crystal Panel: Circuit Substrate The circuit substrate 52 includes, for example, a plurality of electrodes disposed two-dimensionally in plan view, and a plurality of drive circuits each including a thin film transistor (TFT) to individually apply a voltage to a corresponding one of the plurality of electrodes. For example, the circuit substrate 52 may have an electrode and a drive circuit for each sub-pixel. The display unit 2 may include, for example, a driver (not illustrated) that drives each drive circuit according to a signal from an input unit 42 of the display controller 4 described below.

For example, the circuit substrate 52 may control, for each sub-pixel, the electric potential difference between each electrode and an electrode included in an electrode substrate 71 of the color filter layer 54 described below by driving each of the drive circuits according to the control by the display controller 4 to control the electric potential of each electrode. The backlight from the backlight unit 22 may transmit through, for example, the electrodes and the drive circuits included in the circuit substrate 52.

### Display Unit: Liquid Crystal Panel: Liquid Crystal Layer

The liquid crystal layer 53 includes a liquid crystal 61, and a sealing member 62.

The liquid crystal 61 contains therein dispersed crystals whose orientations are aligned in a specific direction by application of a voltage. In particular, for example, the liquid crystal 61 is configured to, for a higher voltage applied, cause the polarization direction of the transmitted light to further rotate. More specifically, the liquid crystal 61 is configured to, for an applied voltage higher than a predetermined value, cause the polarization direction of the transmitted light to rotate approximately 90°. The voltage application to the liquid crystal 61 may be implemented, for example, by the electric potential difference between the voltage applied to each electrode included in the circuit substrate 52 by the circuit substrate 52, and the electrode of the below-described electrode substrate 71 to which a predetermined voltage is applied. Thus, the liquid crystal layer 53 controls the polarization direction of the backlight in each of the sub-pixels in plan view.

As described above, the first polarizer 51 and the second polarizer 55 have different polarization directions of transmitted light. In particular, for example, it is assumed that the first polarizer 51 and the second polarizer 55 each include a linear polarizer, and the polarization directions of transmitted light are perpendicular. In this situation, when the polarization direction of the backlight which has transmitted through the first polarizer 51 does not change, the backlight does not transmit through the second polarizer 55. In contrast, when the polarization direction of the backlight which has transmitted through the first polarizer 51 is rotated by the liquid crystal 61, the transmittance of the backlight through the second polarizer 55 is changed according to the rotation angle of the polarization direction. In particular, when the polarization direction of backlight is rotated 90°by the liquid crystal 61, the backlight transmits through the second polarizer 55 without substantially losing the intensity.

Thus, the liquid crystal panel 23 controls, for example, the orientation of the liquid crystal 61 achieved by the circuit substrate 52 for each sub-pixel, thus controls the intensity of backlight which transmits through the liquid crystal panel 23 for each sub-pixel, and emits the transmitted backlight as the display light.

The sealing member 62 joins the circuit substrate 52 and the color filter layer 54 described below on the peripheral side of the display area DA in plan view, and seals between the circuit substrate 52 and the color filter layer 54 described below. Thus, the liquid crystal 61 is enclosed in the space surrounded by the sealing member 62, the circuit substrate 52, and the color filter layer 54.

### Display Unit: Liquid Crystal Panel: Color Filter Layer

The color filter layer 54 includes an electrode substrate 71, a plurality of color filters 72, and a black matrix 73.

The electrode substrate 71 includes an electrode to which a predetermined electrical potential is applied by, for example, an auxiliary power supply which is not illustrated. The electrode included in the electrode substrate 71 may be commonly formed for a plurality of sub-pixels, for example. Thus, the liquid crystal panel 23 may control the transmittance of the backlight for each sub-pixel by generating the electric potential difference between each electrode of the circuit substrate 52 and the electrode of the electrode substrate 71, and controlling the voltage to be applied to the liquid crystal 61 for each sub-pixel.

Each of the color filters 72 is an optical filter that allows only light with a specific wavelength to pass therethrough, and is formed in each sub-pixel in plan view, for example. For example, the plurality of color filters may include multiple red filters, green filters, and blue filters, and may be disposed in each sub-pixel. Thus, the display unit 2 may use each of red light, green light, and blue light as the light that transmits through each of the color filters 72, and may perform color display in the display area DA. The color filters 72 may be located on the side of the electrode substrate 71, closer to the backlight unit 22.

The black matrix 73 is located on the side of the electrode substrate 71, closer to the backlight unit 22, and on the peripheral side of the display area DA in plan view. The black matrix 73 includes, for example, a light absorbing material, such as black carbon, which absorbs visible light including the backlight. In particular, the black matrix 73 may be joined to the circuit substrate 52 via the sealing member 62. The black matrix 73 reduces the leakage of backlight to the periphery of the display area DA in plan view, for example, by absorbing the backlight.

### Display Unit: Liquid Crystal Panel: Appendix

In the present embodiment, the liquid crystal panel 23 is not limited to the above-described configuration. For example, the liquid crystal panel 23 according to the present embodiment may have various publicly known configurations in related art as long as the liquid crystal panel 23 controls the transmittance of backlight using liquid crystal in each portion of the display area DA in plan view.

### Display Unit: Adhesive Layer

The adhesive layer 24 bonds the below-described black frame layer 25, decorative layer 26, and transparent base material 27 to the housing 21, and fixes the black frame layer 25, the decorative layer 26, and the transparent base material 27 to the housing 21. The adhesive layer 24 may include various adhesives including publicly known adhesives in related art. The black frame layer 25, the decorative layer 26, and the transparent base material 27 may be bonded to each other by a translucent adhesive material which is not illustrated. In this situation, the black frame layer 25, the decorative layer 26, and the transparent base material 27 can be fixed to the housing 21 by the adhesive layer 24 just bonding the black frame layer 25 to the housing 21.

### Display Unit: Black Frame Layer

The black frame layer 25 is located on the peripheral side of the display area DA in plan view, and may be formed, for example, at a position overlapping at least part of the black matrix 73 in plan view. The black frame layer 25 includes, for example, a light absorbing material which absorbs visible light including the backlight, and may include, for example, the same material as the light absorbing material contained in the black matrix 73. Thus, the black frame layer 25 along with the black matrix 73 reduces the leakage of backlight to the periphery of the display area DA in plan view.

### Display Unit: Decorative Layer

The decorative layer 26 is formed at a position overlapping a region including the display area DA in plan view. The decorative layer 26 has a pattern 26P on the opposite side of the backlight unit 22, in other words, on the display direction side in the display area DA of the display unit 2. The pattern 26P may be, for example, various patterns including wood-grain, and in particular, the exterior of the display unit 2 may be a pattern harmonious with the surroundings of the display unit 2.

The decorative layer 26 implements display in the display area DA by transmitting at least part of the backlight which has transmitted through each portion of the liquid crystal panel 23, in other words, the display light. The decorative layer 26 displays the pattern 26P by reflecting at least part of the outside light from the outside of the display unit 2 to the display surface of the display unit 2, in other words, the outside light incident on the transparent base material 27 of the display unit 2.

Thus, the display unit 2 implements display using display light in the area irradiated with the display light which has transmitted through the liquid crystal panel 23 and the decorative layer 26 of the display area DA in plan view. In contrast, the display unit 2 displays the pattern 26P by reflecting the outside light in an area not irradiated with the display light, among areas including the display area DA and the periphery of the display area DA in plan view.

Therefore, the display unit 2 causes the pattern 26P to be visually recognized by a user, thereby harmonizing the display unit 2 with the surroundings as well as making it possible to perform various types of display in the display area DA. In order to make the illustration clearer, the decorative layer 26 in FIG. 2 is formed to be located on the central side rather than the peripheral side of the housing 21 in plan view, but this is not necessarily the case. For example, the decorative layer 26 may be formed at a portion overlapping the entire housing 21 in plan view.

### Display Unit: Transparent Base Material

The transparent base material 27 is located, for example, on the opposite side of the liquid crystal panel 23 with respect to the decorative layer 26. For example, the decorative layer 26 may be bonded to the transparent base material 27, and in this situation, the transparent base material 27 along with the decorative layer 26 and the black frame layer 25 are fixed to the housing 21 via the adhesive layer 24, thus the black frame layer 25, the decorative layer 26, and the transparent base material 27 can be fixed to the housing 21. In this situation, at the time of manufacturing of the display unit 2, the black frame layer 25, the decorative layer 26, and the transparent base material 27 are easily fixed to the housing 21. In the present embodiment, the transparent base material 27 may have a function of protecting the decorative layer 26, or the transparent base material 27 may be a touch panel substrate having translucency so that the display unit 2 is provided with a touch panel function.

### Measurer

Returning to the reference of the block diagram F11 of FIG. 1A, the measurer 3 includes sensors 31 and an intensity acquirer 32. For example, as illustrated in FIG. 2, at least one sensor 31 is formed in the periphery of the decorative layer 26 in plan view of the display unit 2, and on the side of the decorative layer 26, closer to the transparent base material 27. Therefore, the sensors 31 receive part of the outside light emitted to the display unit 2 including the decorative layer 26. The intensity acquirer 32 acquires the intensity of the outside light received by each of the sensors 31.

However, the position of each sensor 31 is not limited to the periphery of the decorative layer 26 in plan view of the display unit 2, and not limited to the side of the decorative layer 26, closer to the transparent base material 27. For example, the sensor 31 may be located inside the decorative layer 26 in plan view of the display unit 2, and on the side of the decorative layer 26, closer to the liquid crystal panel 23. In this situation, for example, the black frame layer 25 may include a translucent unit that allows light to pass therethrough in the emission direction of the display light of the display unit 2, and the sensor 31 may be at a position overlapping the translucent unit in plan view of the display unit 2. In addition, the sensor 31 may be at a position overlapping the display area DA in plan view of the display unit 2. In this situation, the sensor 31 may include a camera or a light receiving element located in the display area DA, such as an under-display camera (UDC).

For example, the sensor 31 may be a light receiving element that converts received light into a voltage. In this situation, the intensity acquirer 32 may be a voltage measurement instrument that obtains the intensity of the outside light received by each sensor 31 measuring the height of the voltage from the sensor 31.

Thus, the measurer 3 measures the intensity of the outside light emitted to the decorative layer 26. The measurer 3 may calculate the outside light illuminance in the space where the display unit 2 is located, from the measured intensity of the outside light. When the sensor 31 is located inside the decorative layer 26 in plan view of the display unit 2 and on the side of the decorative layer 26, closer to the liquid crystal panel 23, the measurer 3 may measure the intensity of outside light in consideration of attenuation thereof which occurs in the decorative layer 26 until the outside light enters the sensor 31.

In the present embodiment, the measurer 3 is not limited to the above-described configuration for measuring the intensity of the outside light using the sensors 31 incorporated in the display unit 2. For example, the measurer 3 may measure the intensity of the outside light using devices installed in the periphery of the display unit 2. For example, when the display unit 2 is installed in the dashboard of an automobile, the measurer 3 may measure the intensity of the outside light based on the information from an in-vehicle camera or an outside light sensor and the like installed in the periphery of the display unit 2.

### Display Controller

Returning to the reference of the block diagram F11 of FIG. 1A, the display controller 4 includes a generator 41, an input unit 42, and a backlight controller 43.

For example, the generator 41 generates a video signal corresponding to the image to be displayed in the display area DA of the display unit 2 according to the signal received from an antenna or the like which is not illustrated. The input unit 42 inputs the video signal from the generator 41 to the display unit 2, in particular, the liquid crystal panel 23, and controls the transmittance of backlight in each portion of the display area DA of the display unit 2. In other words, the display controller 4 controls the light transmittance at each position of the liquid crystal panel 23 in plan view through control of the liquid crystal panel 23. The signal from the input unit 42 may be input to a driver (not illustrated) that drives the drive circuit of the circuit substrate 52 of the liquid crystal panel 23 described above.

The backlight controller 43 controls the intensity of the backlight emitted from each portion of the backlight unit 22 by inputting a signal to the backlight unit 22. In particular, in the present embodiment, the backlight controller 43 corrects the intensity of the backlight emitted from each portion of the backlight unit 22 according to the intensity of the outside light measured by the measurer 3.

As described above, the display controller 4 controls the display light in at least the display area DA according to the image to be displayed in the display area DA by the liquid crystal panel 23 which is a display panel, and the intensity of outside light measured by the measurer 3.

### Correction of Intensity of Backlight

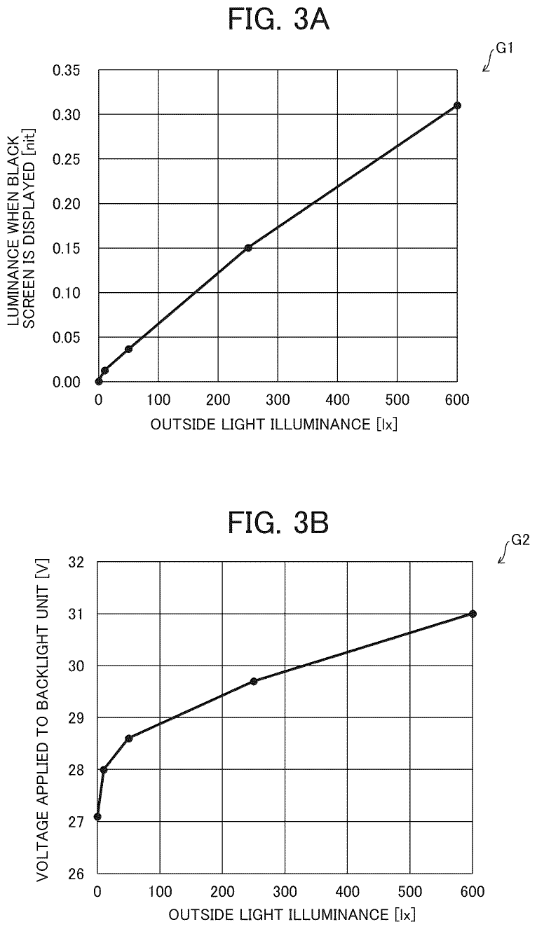

The correction of the intensity of backlight made by the backlight controller 43 will be described in greater detail with reference to FIG. 3A and FIG. 3B.

A graph G1 of FIG. 3A shows a relationship between the outside light illuminance in the space where the display unit 2 is located, and the luminance of each portion of the display area DA when a black screen is displayed in the display area DA of the display unit 2. In the graph G1, the horizontal axis indicates the outside light illuminance (unit: lx), and the vertical axis indicates the luminance (unit: nit).

A graph G2 of FIG. 3B shows a relationship between the outside light illuminance and the voltage applied to the backlight unit 22 of the display unit 2 when a black screen is displayed in the display area DA of the display unit 2.

In the graph G2, the horizontal axis indicates the outside light illuminance (unit: lx), and the vertical axis indicates the applied voltage (unit: V).

For example, as the outside light illuminance increases in the space where the display unit 2 is located, the intensity of the outside light reflected by the decorative layer 26 is enhanced. In particular, when the outside light illuminance is high, the intensity of the outside light reflected by the decorative layer 26, contributing to the display of the pattern 26P on the decorative layer 26 may be higher than the intensity of the display light in the display area DA of the display unit 2. In this situation, display in the display area DA becomes difficult to be visually recognized by a user, and eventually, the display quality in the display area DA may be reduced.

In order to improve the quality of display in the display area DA of the display unit 2, it is desirable that the intensity of the display light in the display area DA be increased for a higher intensity of the outside light reflected by the decorative layer 26. Therefore, in the present embodiment, as the outside light illuminance increases, the luminance in each portion of the display area DA may be further increased.

More specifically, as illustrated in the graph G1, the display controller 4 may control the display unit 2 so that as the outside light illuminance increases, the luminance in each portion of the display area DA increases when a black screen is displayed in the display area DA.

The display controller 4 may control the intensity of backlight by controlling the backlight unit 22 in consideration of the luminance in each portion of the display area DA when a black screen is displayed in the display area DA. Thus, the display controller 4 reduces the difficulty of visual recognition of the display light in the display area DA by a user, and improves the display quality.

In order to increase the luminance in each portion of the display area DA along with an increase in the outside light illuminance, the intensity of backlight may be increased, for example, by enhancing the voltage applied to the backlight unit 22 along with an increase in the outside light illuminance. For example, as illustrated in the graph G2, as the outside light illuminance increases, the voltage applied to the backlight unit at the time of display of a black screen in the display area DA may be increased.

Meanwhile, when the intensity of the display light in the display area DA of the display unit 2 is increased although the outside light illuminance is low, display in the display area DA is performed by display light with an excessive intensity rather than an appropriate intensity, and as a result, the display quality in the display area DA may be reduced. In particular, when the display light in the display area DA is excessive, the outside light reflected by the decorative layer 26, contributing to the display of the pattern 26P on the decorative layer 26 may become difficult to be visually recognized by a user. This may lead to reduced harmony with the surroundings of the display unit 2.

The display device 1 according to the present embodiment is configured to, when the intensity of the outside light reflected by the decorative layer 26 is low, reduce the intensity of backlight through control of the backlight unit 22 by the backlight controller 43, and lower the intensity of the display light in the display area DA.

Therefore, the display device 1 improves the quality of display in the display area DA of the display unit 2.

### Summary of Embodiment 1

As described above, the display device 1 according to the present embodiment measures the intensity of the outside light emitted to the decorative layer 26, and controls the display light in the display area DA according to the intensity. Thus, due to the above-mentioned reason, the display device 1 can improve the display quality in the display area DA. When the outside light illuminance is low, the display device 1 reduces the control of the backlight unit 22 for emitting backlight with an excessive intensity, thus achieves electric power saving.

The display device 1 according to the present embodiment achieves the correction of the intensity of the backlight emitted to the liquid crystal panel 23 through control of the backlight unit 22 by the backlight controller 43. In other words, the display device 1 can correct the intensity of the display light in the display area DA without correcting the video signal input to the liquid crystal panel 23. Thus, the display device 1 achieves the improvement of the display quality in the display area DA with a simpler configuration.

The measurer 3 includes the sensor 31 that receives outside light, and the intensity acquirer 32 that acquires the intensity of the outside light from the sensor 31 which has received the outside light. The display device 1 can perform measurement of the intensity of outside light by the measurer 3 with a higher accuracy while achieving a simpler configuration of the measurer 3.

The backlight unit 22 is assumed to include a plurality of light emitting elements capable of individually changing the emission intensity so that the intensity of backlight can be changed for each position in plan view. In this situation, the backlight controller 43 may control the backlight unit 22 so as to correct the intensity of the backlight for each position in plan view according to the pattern 26P of the decorative layer 26 in addition to the intensity of the outside light emitted to the decorative layer 26.

The pattern 26P of the decorative layer 26 has a different color for each position of the decorative layer 26 in plan view, thus the reflectance of the incident outside light may vary for each position of the decorative layer 26 in plan view. Therefore, depending of the pattern 26P of the decorative layer 26, the intensity of appropriate display light at each position of the display area DA in plan view may vary. The display device 1 further improves the display quality in the display area DA by correcting the intensity of the backlight for each position in plan view according to the pattern 26P of the decorative layer 26.

### Embodiment 2

Another embodiment of the present disclosure will be described below. Note that for the purpose of illustration, members having the same function as that of members described in the above embodiment are labeled with the same symbol, and a description is not repeated.

### Display Panel Including Light Emitting Elements

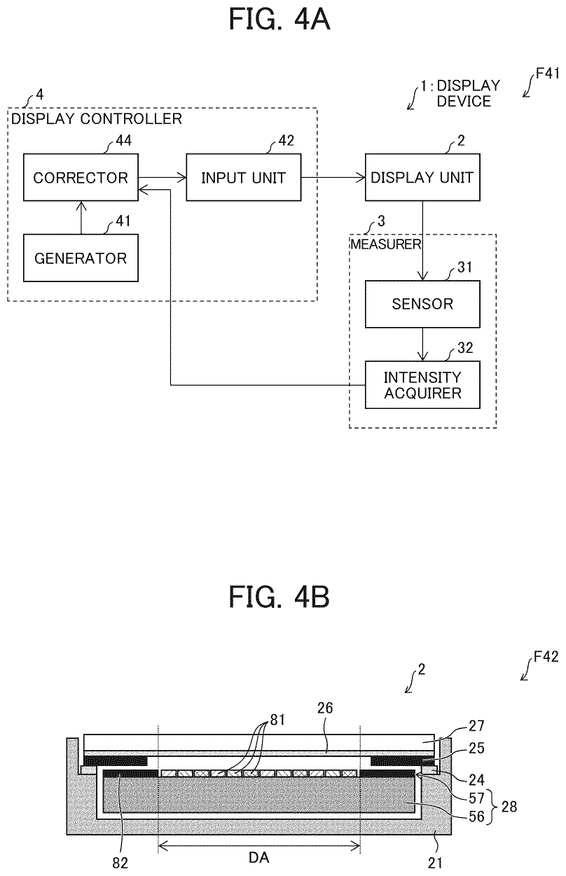

FIG. 4A shows a block diagram F41 of the display device 1 according to the present embodiment. FIG. 4B shows a schematic side sectional view F42 of the display unit 2 according to the present embodiment. In particular, the schematic side sectional view F42 shows a side cross-section of the display unit 2 at a position corresponding to a side cross-section of the display unit 2 illustrated in the schematic side sectional view F12 of FIG. 1B.

Compared with the display unit 2 according to the previous embodiment, the display unit 2 of the display device 1 according to the present embodiment includes the display panel 28 instead of the backlight unit 22 and the liquid crystal panel 23. Except for what has been described above, the display unit 2 according to the present embodiment and the display unit 2 according to the previous embodiment may have the same configuration.

The display panel 28 includes a circuit substrate 56 and a light emitting element layer 57.

The circuit substrate 56 includes a plurality of drive circuits that individually drive the electrode included in each light emitting element 81 of the light emitting element layer 57 described below. The circuit substrate 56 may have the same configuration as that of the circuit substrate 52 except that the electrode to which a voltage is applied by each drive circuit is the electrode of each light emitting element 81 described below.

The light emitting element layer 57 is formed on the side of the circuit substrate 56, closer to the decorative layer 26, and includes a plurality of light emitting elements 81 and a black matrix 82.

The light emitting elements 81 are self-emitting elements disposed two-dimensionally at positions overlapping the display area DA in plan view of the circuit substrate 56. For example, each of the light emitting elements 81 may have an island electrode connected to each of the drive circuits included in the circuit substrate 56. In this situation, the display panel 28 may include a common electrode to which a predetermined electrical potential is applied by an auxiliary electrode which is not illustrated, the common electrode being commonly formed for the plurality of light emitting elements 81 and on the side of the plurality of light emitting elements 81, closer to the decorative layer 26.

Thus, the display panel 28 may individually control the intensity of light emission from each light emitting element 81 by individually controlling the electric potential difference between the island electrode of each light emitting element 81 and the common electrode through the control of each drive circuit of the circuit substrate 56. The light from each light emitting element 81 is taken out from the display panel 28 to the decorative layer 26.

Thus, in the present embodiment, the display light in the display area DA is the light from each light emitting element 81 included in the display panel 28.

The light emitting element 81 according to the present embodiment may be an OLED device (organic EL device) in which a light emitting layer contains e.g., an organic fluorescent material or an organic phosphorescent material. Alternatively, the light emitting element 81 may be a QLED device in which a light emitting layer contains e.g., quantum dots having a light emitting property (semiconductor nanoparticles). The display panel 28 may include each of a plurality of red light emitting elements, a plurality of green light emitting elements, and a plurality of blue light emitting elements as the light emitting elements 81 disposed two-dimensionally on the circuit substrate 56. Thus, the display panel 28 may implement color display in the display area DA.

The black matrix 82 is located on the peripheral side of the display area DA in plan view of the circuit substrate 56. The black matrix 82 includes, for example, a light absorbing material, such as black carbon, which absorbs visible light including the backlight. The black matrix 82 may have the same configuration as that of the black matrix 73 according to the previous embodiment except that the black matrix 82 is formed in the circuit substrate 56.

Compared with the display controller 4 according to the previous embodiment, the display controller 4 of the display device 1 according to the present embodiment includes a corrector 44 instead of the backlight controller 43. The corrector 44 corrects the video signal input from the generator 41 according to the intensity of outside light measured by the measurer 3, and inputs the video signal to the input unit 42. In the present embodiment, the input unit 42 inputs the corrected video signal input from the corrector 44 to the display panel 28 to control the display panel 28.

Thus, the display controller 4 controls the display in the display area DA of the display unit 2. In other words, the display controller 4 controls the intensity of the light emitted by each of the plurality of light emitting elements 81 according to the image to be displayed by the display panel 28 and the intensity of outside light measured by the measurer 3.

In particular, the corrector 44 corrects the input signal so that for a higher intensity of outside light measured by the measurer 3, the luminance of each light emitting element 81 of the display panel 28 is increased.

In other words, the corrector 44 corrects the input signal so that for a lower intensity of outside light measured by the measurer 3, the luminance of each light emitting element 81 of the display panel 28 is decreased. Thus, the display controller 4 can control the display unit 2 so as to improve the display quality in the display area DA of the display unit 2.

The display device 1 according to the present embodiment includes the display panel 28 including a plurality of light emitting elements 81. Thus, the display device 1 can achieve the improvement of the display quality in the display area DA of the display unit 2 through the control of drive of each light emitting element 81. In other words, for example, the display device 1 can achieve the improvement of the display quality in the display area DA of the display unit 2 without the members such as the backlight unit, the polarizer, and the liquid crystal. Therefore, the display device 1 improves the display quality in the display area DA of the display unit 2 while achieving a simpler configuration.

Since the display panel 28 includes the plurality of light emitting elements 81 disposed two-dimensionally in plan view, the display unit 2 can control the intensity of the display light more strictly in each portion of the display area DA in plan view. Thus, the display device 1 can correct the display light at each position of the display area DA in plan view by a simpler configuration or with a high accuracy according to the pattern 26P of the decorative layer 26.

The display controller 4 according to the present embodiment inputs the video signal corrected by the corrector 44 to the display panel 28, thereby correcting the intensity of the light emitted by each light emitting element 81 to make correction of the intensity of the display light in the display area DA. Thus, the display device 1 is capable of correcting the intensity of the display light more accurately than correcting the intensity of the display light indirectly by correcting the intensity of the backlight.

### Embodiment 3

### Adjustment of Characteristics of Gamma Correction

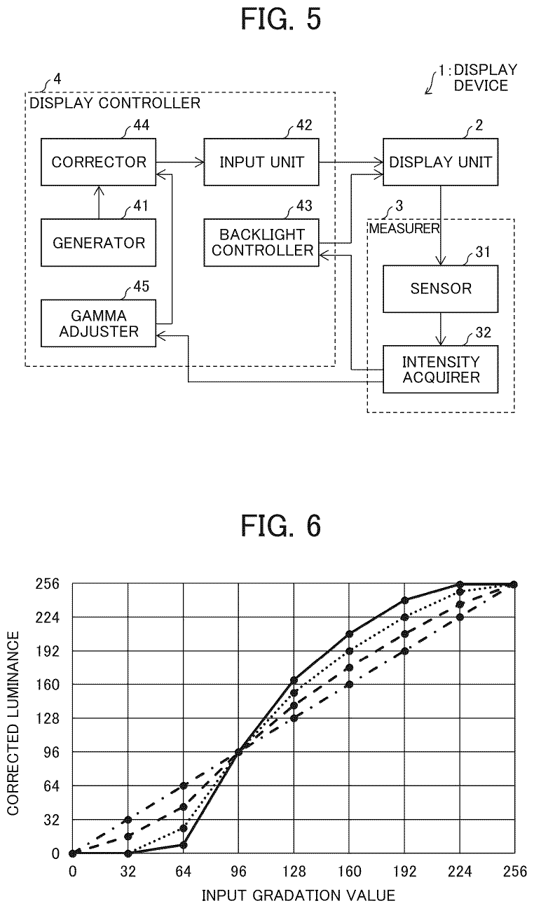

FIG. 5 is a block diagram of the display device 1 according to the present embodiment. Compared with the display device 1 according to Embodiment 1, the display device 1 according to the present embodiment has a different configuration in that the display controller 4 further includes a corrector 44 and a gamma adjuster 45. The display unit 2 and the measurer 3 according to the present embodiment have the same configuration as that of the display unit 2 and the measurer 3 according to Embodiment 1.

The corrector 44 according to the present embodiment performs gamma correction on the image signal input from the generator 41, and inputs the corrected image signal to the input unit 42. The gamma correction by the corrector 44 according to the present embodiment is adjusted by the gamma adjuster 45. In particular, the gamma adjuster 45 adjusts the characteristics of the gamma correction by the corrector 44 according to the intensity of outside light measured by the measurer 3.

The relationship between adjustment of the characteristics of the gamma correction by the gamma adjuster 45 according to the present embodiment, and the intensity of outside light measured by the measurer 3 will be described in greater detail with reference to FIG. 6.

The graph of FIG. 6 shows a relationship between input gradation value and corrected luminance for each outside light illuminance which is calculated from the intensity of outside light measured by the measurer 3. In the graph of FIG. 6, the horizontal axis indicates input gradation value, and the vertical axis indicates corrected luminance. In particular, for the outside light illuminance of 0 lx, 50 lx, 250 lx and 600 lx, respective relationships between input gradation value and corrected luminance are shown by a solid line, a dotted line, a dashed line and a dash-dotted line of FIG. 6.

In the present embodiment, for example, when the outside light illuminance is 600 lx, the corrector 44 performs gamma correction so that the input gradation value and the gradation value corresponding to the actually output luminance are 1:1 regardless of the input gradation value. In other words, in the present embodiment, for example, when the outside light illuminance is 600 lx, the corrector 44 performs normal gamma correction on the input signal. For example, when the outside light illuminance is 600 lx, the gamma adjuster 45 does not have to adjust the gamma correction by the corrector 44. In the graph of FIG. 6, the corrected luminance of the vertical axis is set to be the same as the input gradation value when the outside light illuminance is 600 lx. Thus, when the outside light illuminance is 600 lx, the relationship between input gradation value and corrected luminance is approximately a line.

For example, let G_{A} be the input gradation value, that is, the gradation value of an image signal generated by the generator 41, and let G_{B} be the corrected gradation value, that is, the gradation value of an image signal, corrected by the corrector 44. When the outside light illuminance is 600 lx, the corrected gradation value G_{B} is expressed using a predetermined gamma value γ by G_{B}=G_{A}^{1/γ}.

For example, the gamma value γ varies with the characteristics of the display unit 2, but typically may be 2.2.

Meanwhile, as shown in the graph of FIG. 6, for a lower outside light illuminance, the corrected luminance is further decreased when the input gradation value is low, and the corrected luminance is further increased when the input gradation value is high. In the present embodiment, the gamma adjuster 45 adjusts the characteristics of the gamma correction by the corrector 44 so that the corrected luminance for the input gradation value is further decreased when the input gradation value is low, and the corrected luminance for the input gradation value is further increased when the input gradation value is high as described above.

Thus, the display controller 4 according to the present embodiment can control the display unit 2 so that, of the display area DA, in a light emitting region with a low gradation, the pattern 26P is more likely to be visually recognized, and in a light emitting region with a high gradation, the display light is more likely to be visually recognized. Therefore, the display device 1 according to the present embodiment further improves the display quality in the display area DA.

In the present embodiment, the display controller 4 performs gamma correction on the input gradation value of the video signal by the corrector 44 for each drive circuit of the liquid crystal panel 23. In other words, the display controller 4 corrects the light transmittance by the corrector 44 at each position of the liquid crystal panel 23 in plan view according to the intensity of outside light measured by the measurer 3. Thus, the display device 1 can correct the light transmittance of the liquid crystal panel 23 as appropriate at each position of the display area DA in plan view, and further improves the display quality in the display area DA. Note that in the present embodiment also, the display controller 4 may correct the intensity of backlight according to the intensity of outside light measured by the measurer 3 through the control of the backlight unit 22 by the backlight controller 43.

### Embodiment 4

### Correction of Video Signal Using Correction Data

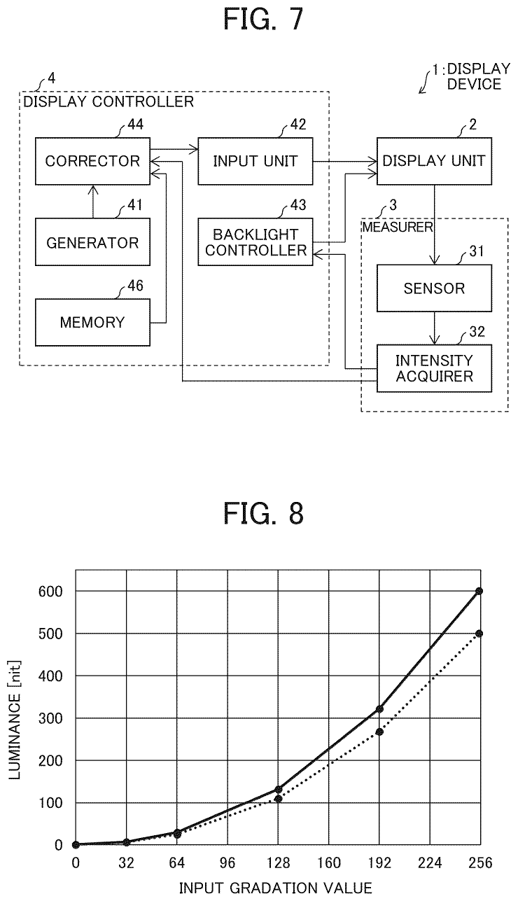

FIG. 7 is a block diagram of the display device 1 according to the present embodiment. Compared with the display device 1 according to Embodiment 1, the display device 1 according to the present embodiment has a different configuration in that the display controller 4 further includes a corrector 44 and a memory 46. The display unit 2 and the measurer 3 according to the present embodiment have respectively the same configurations as the display unit 2 and the measurer 3 according to Embodiment 1.

The memory 46 according to the present embodiment is a storage device that can store data and hold the data at least temporarily, the storage device including various publicly known storage devices in related art. In particular, the memory 46 according to the present embodiment stores correction data including details of correction by the corrector 44 according to the intensity of outside light measured by the measurer 3.

The corrector 44 according to the present embodiment corrects the video signal input from the generator 41 based on the details of correction included in the correction data read from the memory 46, and outputs the corrected video signal to the input unit 42. In other words, the corrector 44 references the correction data from the memory 46, and corrects the video signal according to the intensity of outside light measured by the measurer 3.

The correction data stored in the memory 46 may be, for example, data showing the difference between the luminance as a reference for the gradation value of the video signal, and the luminance obtained when the video signal is input to the liquid crystal panel 23 without being corrected, according to the intensity of the outside light emitted to the display unit 2. The correction of the video signal using the correction data stored in the memory 46 will be described in greater detail with reference to FIG. 8.

The graph of FIG. 8 shows, with a predetermined value of outside light illuminance, the luminance as a reference for gradation value of video signal, and the luminance obtained when the video signal is input to the liquid crystal panel 23 without being corrected. In the graph of FIG. 8, the horizontal axis indicates gradation value of video signal, and the vertical axis indicates luminance (unit: nit). In the graph of FIG. 8, the luminance obtained when the video signal is input to the liquid crystal panel 23 without being corrected is indicated by a solid line, and the luminance as a reference for gradation value of video signal is indicated by a dotted line.

For a predetermined outside light illuminance, the luminance as a reference for gradation value of video signal is determined by calculating a suitable luminance to each gradation value with the outside light illuminance by the method described below. The corrector 44 corrects the gradation value of the video signal to a gradation value with which the luminance as a reference for the gradation value is obtained.

For example, in the example shown by the graph of FIG. 8, the luminance obtained when the video signal is input to the liquid crystal panel 23 without being corrected is higher than the luminance as a reference for the gradation value of the video signal. Thus, in the example shown by the graph of FIG. 8, the corrector 44 corrects and reduces the gradation value of the video signal to a gradation value with which the luminance as a reference is obtained.

For example, as shown in the graph of FIG. 8, there is a difference between the luminance as a reference for input gradation value and the luminance obtained when correction is not made. Thus, the memory 46 stores data on the difference between the luminance as a reference and the luminance obtained when correction is not made for each input gradation value. In particular, the memory 46 may store, as data for each input gradation value, a corrected gradation value to be actually input to the liquid crystal panel 23 for each input gradation value.

Depending on the outside light illuminance, there is a difference between the luminance as a reference for a predetermined input gradation value and the luminance obtained when correction is not made. Thus, the memory 46 stores data on the difference between the luminance as a reference for a predetermined input gradation value and the luminance obtained when correction is not made for each outside light illuminance. In particular, the memory 46 may store, as data for each outside light illuminance, a corrected gradation value to be actually input to the liquid crystal panel 23 for each input gradation value.

The display controller 4 according to the present embodiment references the correction data stored in the memory 46 to correct the video signal, inputs the corrected video signal to the liquid crystal panel 23, and controls the display in the display area DA. Thus, the display device 1 according to the present embodiment improves the display quality in the display area DA with more simplified details of control.

### Generation of Correction Data

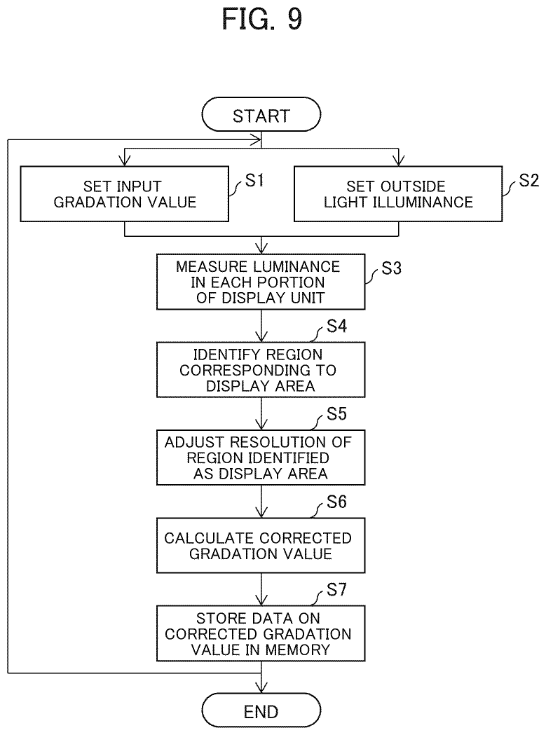

In the present embodiment, the correction data is generated, for example, before product shipment of the display device 1, and is stored in the memory 46. The method for generating correction data will be described with reference to FIG. 9. FIG. 9 is a flowchart illustrating the method for generating correction data of the display device 1 according to the present embodiment.

In the method for generating correction data of the display device 1, for example, an input gradation value and an outside light illuminance are set. Subsequently, when a video signal has the input gradation value and the display unit 2 is located in the space with the outside light illuminance, a corrected gradation value for the video signal, to be input to the liquid crystal panel 23 is calculated. Subsequently, the corrected gradation value is stored in the memory 46. The above process is repeatedly performed while changing the setting of an input gradation value and an outside light illuminance. Thus, data on corrected gradation value according to the input gradation value of the video signal and the outside light illuminance is generated and stored in the memory 46.

More specifically, in the method for generating correction data of the display device 1, for example, an input gradation value is set first (step S1), and an outside light illuminance is set concurrently (step S2).

Subsequently, the luminance in each portion of the display unit 2 is measured with the set value of outside light illuminance while driving the entire surface of the liquid crystal panel 23 with the set input gradation value (step S3). The measurement in step S3 is achieved by a method such as capturing an upper surface including the display area DA of the display unit 2 with a camera.

Subsequently, a region corresponding to the display area DA is identified from information on the luminance in each portion of the display unit 2, obtained in step S3 (step S4). For example, a region with a luminance greater than or equal to a predetermined value is trimmed from the image captured by the above-mentioned camera, and the trimmed region may be identified as the display area DA.

Subsequently, in order to facilitate the identification of corrected gradation value, the resolution of the display area DA and the identified region is adjusted (step S5). Step S5 may be achieved, for example, by enlargement or reduction of the above-mentioned region trimmed from the image.

Subsequently, the luminance in each portion of the region with a resolution adjusted in step S5 is analyzed, and a corrected gradation value is calculated (step S6).

Step S6 may be performed, for example, in the following manner: an ideal luminance for the set input gradation value and outside light illuminance is compared with the actual luminance in each portion of the region, and a corrected gradation value for the set input gradation value is set from the calculated luminance difference. The corrected gradation value calculated in step S6 corresponds to the input gradation value and the outside light illuminance which are set in step S1 and step S2.

Subsequently, data on corrected gradation value is stored in the memory 46, the data linking the calculated corrected gradation value to the input gradation value and the outside light illuminance which are set in step S1 and step S2 (step S7). Thus, the data on corrected gradation value corresponding to the input gradation value and the outside light illuminance set in step S1 and step S2 is stored in the memory 46.

The above step S1 to step S7 are repeatedly performed while changing the input gradation value and the outside light illuminance. Thus, generation of correction data and storing of the correction data to the memory 46 according to the present embodiment are completed.

Correction Data at Each Position of Display Area For example, as described above, depending of the pattern 26P of the decorative layer 26, the intensity of appropriate display light at each position of the display area DA in plan view may vary. Thus, the reference luminance of the display light may vary with the position of the display area DA in plan view. Therefore, in the present embodiment, the correction data stored in the memory 46 may include information on the reference luminance of display light for the intensity of the outside light emitted to the decorative layer 26 at each position of the liquid crystal panel 23 in plan view.

In this situation, the corrector 44 may correct the video signal by comparing the intensity of outside light measured by the measurer 3 with the reference luminance obtained from the correction data stored in the memory 46 at each position of the liquid crystal panel 23 in plan view.

Thus, the display controller 4 can correct the luminance of the display light in the display area DA at each position of the display area DA in plan view with more simplified details of control. Therefore, the display device 1 having the above configuration further improve the display quality in the display area DA while further simplifying the details of control of the liquid crystal panel 23.

Correction data may be generated by changing part of the method described with reference to FIG. 9, the correction data including the information on the reference luminance of display light for the intensity of the outside light emitted to the decorative layer 26 at each position of the liquid crystal panel 23 in plan view.

For example, in the method for generating correction data in the present embodiment, a predetermined region in plan view of the display area DA may be set in addition to step S1 and step S2. Subsequently, in step S3, only the drive circuits located in the set predetermined region in the display area DA may be driven with the input gradation value set in step S1, and the luminance of each portion of the display unit 2 may be measured.

Subsequently, in step S4, the above-mentioned predetermined region may be identified instead of identifying the region corresponding to the display area DA, and in step S5, the resolution of the identified predetermined region may be adjusted.

In this situation, the corrected gradation value calculated in step S6 is a corrected gradation value corresponding to the above-mentioned predetermined region in addition to the input gradation value and the outside light illuminance set in step S1 and step S2. In step S7, data on corrected gradation value may be stored in the memory 46, the data being linked to the input gradation value with a corrected gradation value set, the outside light illuminance, and positional information on the predetermined region.

The above step S1 to step S7 may be repeatedly performed while changing the input gradation value, the outside light illuminance, and the position of the predetermined region. Thus, generation of correction data corresponding to each position of the display area DA in plan view and storing of the correction data to the memory 46 are completed.

A display device according to a first aspect of the present disclosure includes: a display panel configured to emit display light; a decorative layer located on a display surface side of the display panel and having a pattern in plan view, the decorative layer being configured to allow at least part of the display light to transmit and reflect at least part of outside light to display the pattern; a measurer configured to measure an intensity of the outside light emitted to the decorative layer; and a display controller configured to control the display light according to an image displayed on the display panel and the intensity of the outside light measured by the measurer.

A display device according to a second aspect of the present disclosure is the display device according to the first aspect in which the display panel may be a liquid crystal panel including a liquid crystal layer, the display device may further include a backlight unit configured to emit backlight to the liquid crystal panel, the display controller may control a light transmittance at each position of the liquid crystal panel in plan view through control of the liquid crystal panel, and the display controller may include a backlight controller that controls an intensity of the backlight through control of the backlight unit.

A display device according to a third aspect of the present disclosure is the display device according to the second aspect in which the backlight controller may correct the intensity of the backlight according to the intensity of the outside light measured by the measurer.

A display device according to a fourth aspect of the present disclosure is the display device according to the second or third aspect in which the display controller may correct a light transmittance at each position of the liquid crystal panel in plan view according to the intensity of the outside light measured by the measurer.

A display device according to a fifth aspect of the present disclosure is the display device according to the first aspect in which the display panel may include a plurality of light emitting elements, the display light may be light emitted by each of the plurality of light emitting elements, and the display controller may control an intensity of the light emitted by each of the plurality of light emitting elements according to an image displayed on the display panel and the intensity of the outside light measured by the measurer.

A display device according to a sixth aspect of the present disclosure is the display device according to any one of the first to fifth aspects in which the measurer may include a sensor that receives the outside light, and an intensity acquirer that acquires an intensity of the outside light received by the sensor.

A display device according to a seventh aspect of the present disclosure is the display device according to any one of the first to sixth aspects in which the display controller may include a generator that generates a video signal corresponding to an image to be displayed, a corrector that corrects the video signal, and an input unit that inputs the video signal to the display panel, and the corrector may correct the video signal according to the intensity of the outside light measured by the measurer.

A display device according to an eighth aspect of the present disclosure is the display device according to the seventh aspect in which the corrector may perform gamma correction on the video signal, and the display controller may include a gamma adjuster that adjusts characteristics of the gamma correction according to the intensity of the outside light measured by the measurer.

A display device according to a ninth aspect of the present disclosure is the display device according to the seventh or eighth aspect in which the display controller may include a memory that stores correction data including details of correction by the corrector according to the intensity of the outside light measured by the measurer, and the corrector may reference the correction data from the memory and correct the video signal according to the intensity of the outside light measured by the measurer.

A display device according to a tenth aspect of the present disclosure is the display device according to the ninth aspect in which the correction data may include information on a reference luminance of the display light for the intensity of the outside light emitted to the decorative layer at each position of the display panel in plan view, and the corrector may correct the video signal by comparing the intensity of the outside light measured by the measurer with the reference luminance at each position of the display panel in plan view.

The present disclosure is not limited to the above-described embodiments, and various modifications are possible in the scope of the appended claims. Embodiments obtained by combining the technical units disclosed in different embodiments as appropriate are also included in the technical scope of the present disclosure. In addition, a new technical feature can be formed by combining the technical units disclosed in the embodiments.

For example, the display controller 4 of the display device 1 according to Embodiment 3 or Embodiment 4 may correct the intensity of backlight through the control of the backlight unit 22 by the backlight controller 43. In this situation, the corrector 44 of the display controller 4 may correct the video signal in consideration of the correction of the intensity of the backlight.

The display unit 2 of the display device 1 according to Embodiment 3 or Embodiment 4 may include the display panel 28 according to Embodiment 2 instead of the liquid crystal panel 23. In this situation, the display controller 4 does not have to include the backlight controller 43. In this situation, the input unit 42 of the display controller 4 may input the video signal corrected by the corrector 44 to the display panel 28.

The present disclosure contains subject matter related to that disclosed in Japanese Priority Patent Application JP 2024-150824 filed in the Japan Patent Office on Sep. 2, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display panel configured to emit display light;
a decorative layer located on a display surface side of the display panel and having a pattern in plan view, the decorative layer being configured to allow at least part of the display light to transmit and reflect at least part of outside light to display the pattern;
a measurer configured to measure an intensity of the outside light emitted to the decorative layer; and
a display controller configured to control the display light according to an image displayed on the display panel and the intensity of the outside light measured by the measurer.

2. The display device according to claim 1,
wherein the display panel is a liquid crystal panel including a liquid crystal layer,
the display device further includes a backlight unit configured to emit backlight to the liquid crystal panel,
the display controller controls a light transmittance at each position of the liquid crystal panel in plan view through control of the liquid crystal panel, and
the display controller includes a backlight controller that controls an intensity of the backlight through control of the backlight unit.

3. The display device according to claim 2,
wherein the backlight controller corrects the intensity of the backlight according to the intensity of the outside light measured by the measurer.

4. The display device according to claim 2,
wherein the display controller corrects a light transmittance at each position of the liquid crystal panel in plan view according to the intensity of the outside light measured by the measurer.

5. The display device according to claim 1,
wherein the display panel includes a plurality of light emitting elements,
the display light is light emitted by each of the plurality of light emitting elements, and
the display controller controls an intensity of the light emitted by each of the plurality of light emitting elements according to an image displayed on the display panel and the intensity of the outside light measured by the measurer.

6. The display device according to claim 1,
wherein the measurer includes a sensor that receives the outside light, and an intensity acquirer that acquires an intensity of the outside light received by the sensor.

7. The display device according to claim 1,
wherein the display controller includes a generator that generates a video signal corresponding to an image to be displayed, a corrector that corrects the video signal, and an input unit that inputs the video signal to the display panel, and
the corrector corrects the video signal according to the intensity of the outside light measured by the measurer.

8. The display device according to claim 7,
wherein the corrector performs gamma correction on the video signal, and
the display controller includes a gamma adjuster that adjusts characteristics of the gamma correction according to the intensity of the outside light measured by the measurer.

9. The display device according to claim 7,
wherein the display controller includes a memory that stores correction data including details of correction by the corrector according to the intensity of the outside light measured by the measurer, and
the corrector references the correction data from the memory and corrects the video signal according to the intensity of the outside light measured by the measurer.

10. The display device according to claim 9,
wherein the correction data includes information on a reference luminance of the display light for the intensity of the outside light emitted to the decorative layer at each position of the display panel in plan view, and
the corrector corrects the video signal by comparing the intensity of the outside light measured by the measurer with the reference luminance at each position of the display panel in plan view.
